(19) United States
(12) Patent Application Publication
(10) Pub. No.: US 2024/0048521 A1
(43) Pub. Date: Feb. 8, 2024

(54) RECOMMENDING CONTENT TO USER ACCOUNTS ON A SOCIAL MESSAGING PLATFORM

(71) Applicant: Twitter, Inc., San Francisco, CA (US)

(72) Inventors: Ga Wu, Toronto (CA); Jun Ping Ng, Lexington, MA (US); Yael Brumer, Redmond, WA (US)

(21) Appl. No.: 17/879,732

(22) Filed: Aug. 2, 2022

(51) Int. Cl. H04L 51/52; H04L 51/07; G06Q 50/00

(52) U.S. Cl. CPC H04L 51/52; H04L 51/07; G06Q 50/01

(57) ABSTRACT

Methods, systems, and apparatus, including computer programs encoded on computer storage media, for updating embeddings for user accounts on a social messaging platform. One of the methods includes receiving data having multiple data tuples, each data tuple indicating a user account and an item that the user account engaged with on the social messaging platform. A portion of the data is assigned to a respective multiple clusters. Embeddings are updated using an assigned cluster for each portion of the data. The updating includes: for each iteration step of multiple iteration steps, first embeddings are updated based on a first variable coefficient and a second variable coefficient. The updated first embeddings are stored into respective temporary data structures, which are then aggregated to generate aggregated first embeddings in a preserved data structure. Second embeddings are updated based on the aggregated first embeddings.

### BACKGROUND

This specification relates to a social messaging platform, and in particular, to updating embeddings for recommending content to user accounts on the social messaging platform.

Social messaging platforms and network-connected personal computing devices allow users to create and share content across multiple devices in real-time.

Sophisticated mobile computing devices such as smartphones and tablets make it easy and convenient for people, companies, and other entities to use social networking messaging platforms and applications. Popular social messaging platforms generally provide functionality for users to draft and post messages, including video content, both synchronously and asynchronously, to other users. Other common features include the ability to post messages that are visible to one or more identified other users of the platform, to other users by virtue of a connection to the authoring user on the platform, or even publicly to any user of the platform without specific designation by the authoring user. Examples of popular social messaging platforms include Facebook, Instagram, Pinterest, and Twitter. (“Facebook” and “Instagram” are trademarks of Facebook, Inc. “Pinterest” is a trademark of Pinterest, Inc. “Twitter” is a trademark of Twitter, Inc.)

### SUMMARY

It can be important to develop efficient and accurate techniques for recommending personalized content to user accounts on a social messaging platform. Due to the large number of user accounts and items (e.g., posts including messages, videos, or symbols) posted by the user accounts, it is difficult, from both training and inference perspectives, to improve the scalability and/or decrease the latency for providing personalized recommendation. When the number of user accounts and items become larger than a threshold value, even simple matrix factorization operations can take hours and/or days to converge for a batch of input data.

Furthermore, the trained features/models might be valid only for a short period of time before requiring re-training or fine-tuning due to the transient nature of items posted on the social messaging platform. For example, discussions about popular or trending events, news, or messages on the social messaging platform might often last for a few days and then fade away, followed by the rise of discussions regarding different events, news, or messages.

In addition, messages posted on the social messaging platform can sometimes lack semantic meaning, e.g., being concise and not including complete context for the messages, which accordingly hinders the accuracy and efficiency for a recommendation system to determine personalized content for recommendation.

Moreover, content engagement and/or user activity on a social messaging platform is generally dynamic and even “unstable” because, for example, (i) user accounts might be sporadically active (e.g., a user account can be active for a first couple of days and then become inactive for a couple of weeks), and/or (ii) content posted in the social messaging platform can be time sensitive (e.g., a post related to a voting campaign can attract a great amount of engagement during a campaign period, but quickly ebbs away after the campaign period.) Therefore, the training process in an interest recommendation system can be seemingly in “waves,” e.g., for a period of time the system has a great amount of data for updating embeddings of one or more user accounts, but for a next period of time, the system might have only a small amount of data for updating. In addition, because the system needs to “re- converge” embeddings after the new data is introduced into the system, unnecessary or unwarranted updates can occur for user accounts with embeddings that have been updated many times, which can be detrimental to the training quality and efficiency.

Previous techniques for providing recommendations have a number of drawbacks. For example, one existing technique, based on matrix factorization techniques, determines user account embeddings and item embeddings based on a user account-relationship graph. A user account-relationship graph includes multiple nodes and multiple edges each connecting two neighboring nodes, where each node indicates a user account on the social messaging platform, and each edge indicates a user account relationship between two connected nodes, e.g., followed, liked, blocked, or other suitable relationships. The embeddings are binary embeddings and are projected into a high dimensional embedding space. Accordingly, this technique is essentially a clustering system that groups user accounts into multiple clusters, which often suffers from over-fitting and lacks ability to recommend content to a particular user account outside the “social circle” of the particular user account's (e.g., content/messages authored by user accounts that the particular user account has not followed or interacted with before). For example, such a technique is not accurate for user accounts that are new to the social messaging platform and have not established a reasonable social circle on the platform. Furthermore, existing update techniques for determining user account embeddings and item embeddings, such as the Alternative Least Square (ALS) technique and the Stochastic Gradient Descent (SGD) technique, often fail to provide satisfactory performance. For example, the ALS technique is known to have scalability issues due to exceeding feasible memory bandwidths. This is because, for example, the ALS technique needs to compute the inverse of huge (and sometimes sparse) embedding matrices, and needs to load at once the entire user account embeddings and/or item embeddings into memory. The SGD technique, although easy to scale, is susceptible to imperfect input data (such as insufficient data for inactive user accounts, or outlier input data) and/or scalability issues, and can be difficult to converge for parallel computations.

This specification describes technologies for recommending content to user accounts on the social messaging platform based on updated embeddings. The embeddings include user account embeddings representing user account preferences or interests, and corresponding item embeddings representing items on the social messaging platform that user accounts have engaged or interacted with, e.g., messages. More specifically, the technologies describe processing of data streams representing user account-item engagements received within a time period that includes multiple data tuples. Each data tuple includes a user account associated with a corresponding user and an item that the user account engaged with on the social messaging platform at a previous time. The system can map the features associated with user accounts and items that corresponding user accounts have engaged with into embeddings in an embedding space. In the following specification, the mapped user account features are also referred to as user account embeddings, and the mapped item features are also referred to as item embeddings. In some implementations, the respective engagements are also projected into the embedding space as engagement embeddings, and the embeddings, collectively, further include the engagement embeddings.

Determining user account preferences is asymmetric and asynchronous. The system uses multiple agents (e.g., processors with multiple computation units) to asynchronously update user account embeddings according to an update technique recursively or repeatedly until a check point. The updated user account embeddings can generally represent user account preferences or interests, and can be used for a recommendation system in the social messaging platform for providing content to corresponding user accounts based at least on the respective user account embeddings. The update technique described in this specification is asymmetric, which includes different gates (e.g., different coefficients or weights) in the update technique and leverages the gates to preclude redundant and/or unnecessary updates in user account embeddings. The asynchronously-updated user account embeddings from different agents are first stored in temporary data structures, and are then aggregated (or synchronized) to generate preserved data structures periodically. The preserved data structures can be further used to determine or update item embeddings. In some implementations, the user account embeddings and item embeddings can be both used for determining content to provide to corresponding user accounts. Furthermore, the described techniques can include a history playback mechanism to prevent the system from forgetting user account preferences for inactive user accounts that are learned at a previous time.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

The subject matter described in this specification can resolve the above-noted difficulties and can be implemented in various embodiments and may result in one or more of the following advantages. A system performing the described techniques can improve the efficiency and the accuracy of determining user interests or user preferences in a dynamic and even “unstable” training environment. More specifically, the system uses a special update technique that includes a “locker” mechanism to improve the stability of updating user account embeddings. For example, the locker mechanism can determine whether data for updating embeddings are accurate and/or reliable, and/or whether the current user account embeddings are well-trained and no need to be updated based on input data streams. Accordingly, redundant, unnecessary, and/or even erroneous updates in user account embeddings can be avoided. The accuracy of determining user account embeddings, the accuracy of item embeddings determined based on the user account embeddings, and/or the accuracy of user preferences determined based at least upon (i) the user account embeddings and/or (ii) the item embeddings are thus improved as well.

Furthermore, this specification describes techniques that can improve the scalability for determining interests or preferences of a large number of users. To achieve this, a system performing the described techniques can include multiple agents for updating user account embeddings when the system is recommending content based on the user account embeddings, (e.g., on the fly, or the updating process can be performed online). Each agent is assigned with a respective portion of input data stream received in a time period and is configured to asynchronously update user account embedding' s for the assigned portion. The updated user account embeddings are asynchronously stored in temporary data structures and then aggregated/synchronized periodically. Note that the updating process is performed online, which further avoids the data staleness issues that are commonly faced by offline models where embeddings are obtained after processing all input data streams.

In addition, the described techniques can further improve the robustness for determining content to provide to user accounts by using a star-shape user-item model. The items can be grouped into mutually-independent properties. Taking a message posted on the social messaging platform as an example, the different properties can include at least one of a keyword for the message, a hashtag posted with the message, a geographical location associated with the message, or an author account that posted the message, just to name a few examples. The independence of different properties allows the system to explicitly determine metadata embeddings for different properties of an item.

Moreover, the described techniques can effectively address the challenge of forgetting older knowledge when interacting with newer environments. This challenge becomes noticeable when a system updates embeddings using input data streams having mostly engagements by active user accounts, and therefore gradually “forgets” user preferences for inactive user accounts. This is because, for example, the embeddings of inactive user accounts are not adequately updated compared to those of active user accounts, and thus deviate from actual embeddings due to the latent representation space shift. A system performing the described techniques can address this challenge by performing a history playback mechanism (or experience replay mechanism). The playback mechanism is configured to include replay data representing the latest engagement records for all user accounts, so that when updating embeddings, the system processes the replay data together with the received data stream for a new time period.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by a data processing apparatus, cause the apparatus to perform those operations or actions. That special-purpose logic circuitry is configured to perform particular operations or actions means that the circuitry has electronic logic that performs those operations or actions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example social messaging platform and example user devices configured to interact with the platform.

FIG. 2 is a diagram illustrating an example content recommendation system.

FIG. 3 is a flowchart of an example process for determining content to recommend to a particular user account.

FIG. 4 is a flowchart of an example process of updating embeddings.

Like reference numbers and designations in the various drawings indicate like elements.

### DETAILED DESCRIPTION

A social messaging platform may have many millions of accounts, anywhere from hundreds of thousands to millions of connections may be established or in use between clients and the platform at any given moment. Users of the social messaging platform can post messages that are visible to other users, and engage with messages authored by other users. The messages across the social messaging platform can be on different topics. Such messages include rich and valuable information. For example, the messages may be associated with different items. Users of the social messaging platform can have different interests.

Techniques described herein are related to recommending content for a particular user account on the social messaging platform, and can be easily scaled up for large numbers of user accounts and items. Accounts of the social messaging platform can be related to various entities including individual users, organizations, or businesses. In some instances, accounts associated with particular individuals are referred to as “user accounts.” However, the term “account” alone can encompass accounts associated with any type of entity.

First, the techniques allow the system to be trained using streaming input data that includes interaction signals between user accounts and corresponding items from mutual- independent properties. The training process can be performed online. In addition, the update technique described in this specification for updating user account embeddings and item embeddings is asymmetric, which includes one or more gate functions for resisting unnecessary and/or un-trustworthy updates. Further, the system can use multiple agents (e.g., processors, clusters, computation units) for iteratively updating embeddings in an asynchronous fashion. In other words, each agent can update corresponding embeddings based on assigned input data and does not need to wait for output from other agents. The system eventually synchronizes embedding updates periodically. Moreover, the techniques further include a history playback mechanism to store particular input data received at an initial time period and provide the particular input data for training the system at a later time period. In this way, the system does not forget previously learned embeddings, especially for user accounts that are or become inactive after the initial time period.

The techniques described in this specification accordingly improve the accuracy and efficiency for determining personalized recommendation to user accounts because they facilitate the convergence by preventing unnecessary and/or unwarranted updates in the embeddings, and as well prevent “memory loss” caused by inactive user accounts. The techniques further address the scalability issue by utilizing multiple agents to concurrently and asynchronously perform inference and/or training operations, and the updated/optimized embeddings are synchronized and stored in a database periodically.

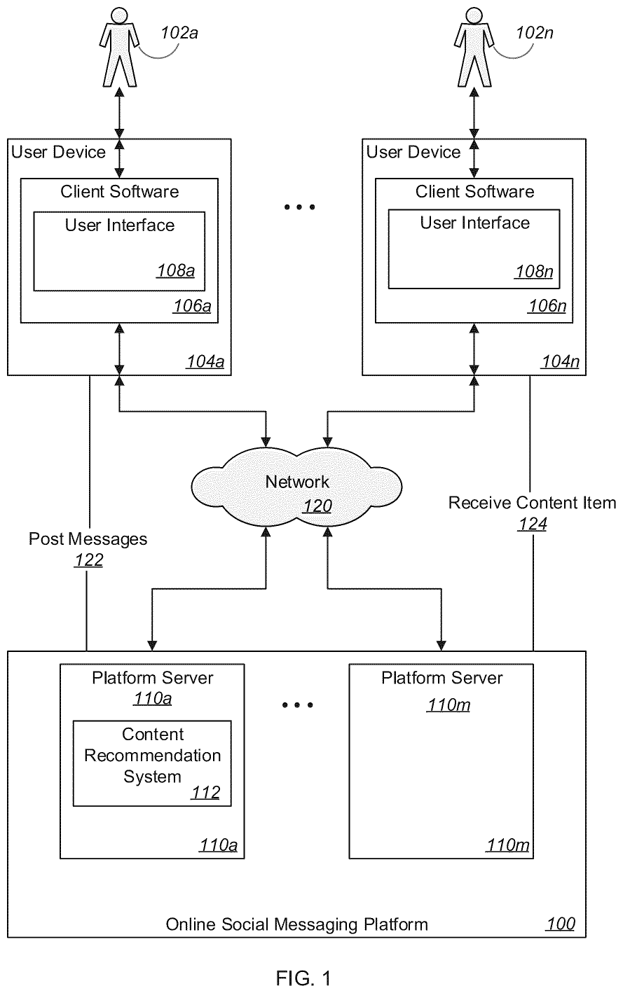

FIG. 1 illustrates an example online social messaging platform 100, which is also referred to simply as a “platform”, and example user devices 104a-104n configured to interact with the platform 100 over one or more wired or wireless data communication networks 120. The data communication networks 120 can include a local area network (“LAN”), wide area network (“WAN”), the Internet, or a combination thereof

Users 102a-102n of the platform use their user devices, on which client software 106a-106n is installed, to use the platform. Each user of the platform is associated with a user account. A user device 104a-104n can be any Internet-connected computing device, e.g., a laptop or desktop computer, a smartphone, or an electronic tablet. The user device can be connected to the Internet through a mobile network, through an Internet service provider (ISP), or otherwise. Each user device 104a-104n is configured with software, which will be referred to as a client or as client software 106a-106n, that in operation can access the platform 100 so that a user can post and receive messages, view, interact with, and create streams of messages and other content items, and otherwise use the service provided by the platform 100.

The platform 100 is implemented on one or more servers 110a-110m in one or more locations. Each server 110a-110m is implemented on one or more computers, e.g., on a cluster of computers.

The platform 100, the user devices 104a-104n, or both are configured to perform one or more of the functions of techniques described herein. In some implementations, users 102a-102n of the platform can post messages 122 using their user devices 104a-104n on the platform. The platform 100 can receive the posted messages from the user devices 104a-104n over the network 120. The messages can include text messages, audio stream messages, and video messages. The messages received across the platform can include rich information from different users of different locations, about different topics, in different conversations, and among different groups.

Further information about user devices, clients, servers, and the platform is provided later in this specification.

One or more of the servers 110a-110m implement a content recommendation system 112 configured to determine content for recommending to user accounts based on corresponding embeddings determined for the users. More specifically, the content recommendation system 112 can process input data stream to update embeddings for according to an update technique. The input data stream includes multiple data tuples, where each tuple represents a user account and a corresponding item (e.g., a posted message) on the social messaging platform that the user account has engaged with. The update technique is generally asymmetric as it includes coefficients to determine whether an update is necessary for embeddings obtained at a previous step, and/or whether one or more data tuples are merited for updating the embeddings.

The content recommendation system 112 can include one or more engines, modules, processors, or computation components and instructions that, when executed, causes the one or more engines, modules, processors, or computation components to perform operations described in this specification. The content recommendation system 112 can be implemented as one or more computer programs installed on one or more computers in one or more locations that are coupled to each other through a network. In cloud-based systems, for example, content recommendation system 112 can be implemented by individual computing nodes of a distributed system.

In some implementations, the platform 100 can include one or more databases (not shown) configured to store various data. For example, a message database may be configured to store the messages. A user database may be configured to store user attributes of users, e.g., geographical information associated with a user account, a relation graph representing other user accounts that a user account follows, or user engagements with posted messages and conversations. An interest database may be configured to store predicted interests for user accounts. A model database may be configured to store trained machine learning models for predicting user interests, or store pre-trained machine learning models for training. The platform 100 can include any number of other databases configured to store any other relevant information for performing the one or more of the functions of techniques described in this specification. The content recommendation module 112 can query information from the database and store information into the database.

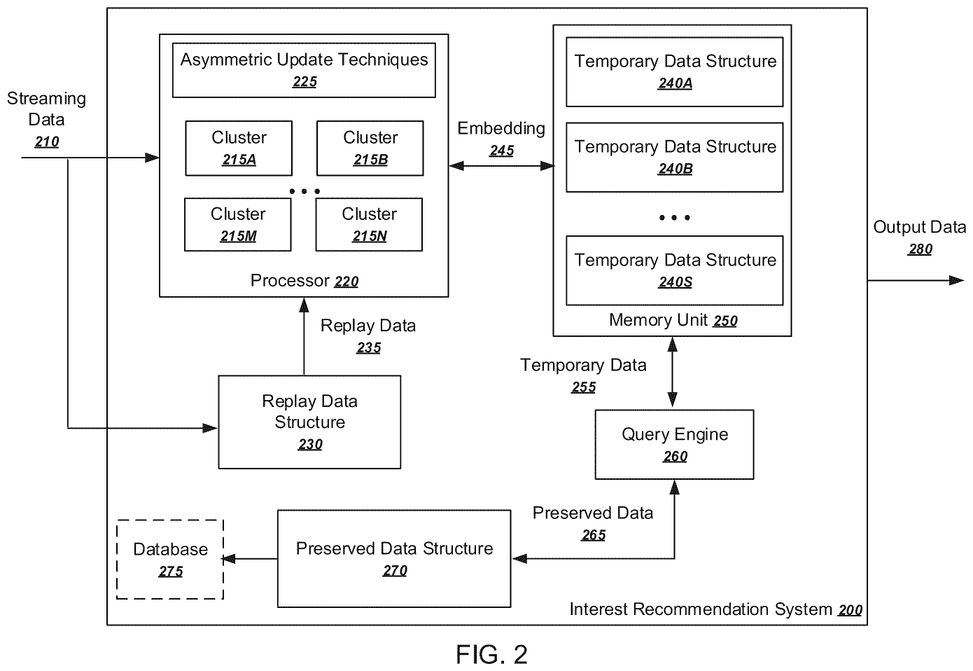

The content recommendation system 112 can repeatedly update embeddings using multiple agents (e.g., processors or clusters having multiple computation units). Each agent can include one or more of a central processing unit (CPU), a graphic processing unit (GPU), a tensor processing unit (TPU), or other suitable processors. The content recommendation system 112 can assign a respective portion of input data stream to each agent. Each agent is configured to update embeddings using temporary data structures based on the assigned portion asynchronously (e.g., agents are not required to wait for other agents to update embeddings). The content recommendation system 112 is configured to synchronize temporary data structures periodically to determine aggregated user account embeddings. Based on the aggregated user account embeddings, the content recommendation system 112 determines item embeddings, which are used, together with the aggregated user account embeddings, by the content recommendation system 112 (or other downstream engines) to determine content to recommend to corresponding user accounts on the social messaging platform. More details of the components of the content recommendation system 112 and algorithms and/or techniques performed by the content recommendation system 112 for updating embeddings are described in connection with FIGS. 2-4.

FIG. 2 is a diagram illustrating an example content recommendation system 200. In some implementations, the content recommendation system 200 is the same as the content recommendation system 112 shown in FIG. 1. The content recommendation system 200 can be implemented by one or more computers located at one or more different locations. The content recommendation system 200 can perform one or more of i) determining embeddings for user accounts and corresponding items that the user accounts have engaged with in a previous time period, ii) determining, based on the determined embeddings, content that might interest the user accounts, or iii) generating recommendations, based on the determined content, to provide to corresponding user accounts.

As shown in FIG. 2, the content recommendation system 200 generally receives streaming data 210 as input, and generates output data 280 after processing the streaming data 210. The streaming data 210 are received by the system 200 for a particular time period or time window. For example, the system 200 can receive a first batch of streaming data 210 during a first time period, and receive a second batch of streaming data 210 during a second time period. Each time period can include any suitable time window according to different analysis requirements. For example, in some instances the time period has a chosen duration of seconds, minutes, or hours.

Streaming data 210 generally includes a sequence of multiple data tuples. The sequence can be ordered chronologically, e.g., according to time points when the data tuples are received by the social messaging platform. Each data tuple indicates a user account and an item that the user account is engaged with on the social messaging platform. The term “user account” generally refers to accounts registered by entities on the social messaging platform, and the term “items” generally refer to messages, conversations, content associated with the messages and/or conversations (e.g., video or audio data), or other content authored or shared by one or more user accounts. Each data tuple in the streaming data 210 can be represented as (i, j), where i stands for a user identifier or index for a user account, and j stands for an item identifier or index for an item that the corresponding user account engaged with at a previous time. The sequence of data can include a vector or matrix storing these data tuples.

In some implementations, a data tuple can represent multiple items that a user account engaged during a particular time period, e.g., (i, j₁, j₂, . . . , j_{N}). In some implementations, the engagement with an item by a particular user account can be represented by an engagement signal that indicates a time when an engagement occurred and a measure associated with the engagement (e.g., positive or negative engagement). The engagement signal can be represented as s=(i,j, t), which represents a measured interaction between user account i and item j at time t.

In addition, the streaming data 210 can further include metadata associated with items. The system can determine and update metadata embeddings for the received metadata. Alternatively, the streaming data 210 can further include metadata embeddings, noted as hⱼ for item j. In some implementations, the system 200 uses a star-shape model that associates a user account with properties of an item engaged by the user account. The model is star-shaped because different properties are mutually independent, and the metadata embeddings can therefore be explicitly estimated for different properties of an item. The multiple mutual-independent properties of an item can include at least one or more properties of, taking a posted message for example, a topic of the message, a keyword for the message, a hashtag posted with the message, a geographical location associated with the message, a language associated with the message, or an author account that posted the message. In general, metadata embeddings associated with an item can represent respective embeddings for properties of an item. For example, metadata embeddings for a topic of a message can include embeddings of different topics such as “machine learning,” “Basketball,” “Global Commercial,” or other topics. Because different properties of an item are mutually independent with one another, the interest recommendation system 200 can reduce a sparsity of observations by using a filter to remove unwanted properties or features based on the metadata embeddings, and the interest recommendation system 200 can further use simple models, e.g., Naïve Bayes, to predict embeddings for a different properties of items.

The output data 280 can include customized content for recommending to one or more user accounts. For example, the output data 280 can include one or more messages related to topics that might interest a particular entity associated with a user account, one or more user accounts recommended for a user account to follow, or other information that a user account might be interested in.

The interest recommendation system 200 includes a processor 220 for processing the streaming data 210. The processor 220 is configured to process the streaming data 210 for updating embeddings (e.g., user account embeddings and/or item embeddings). A processor 220 can include one or more suitable hardware processors such as a central processing unit (CPU), a graphics processing unit (GPU), or a tensor processing unit (TPU). To accelerate updating, the processor 220 can include multiple clusters (215A-N) for performing the updating operations in parallel. A cluster 215 in a processor 220 can include one or more suitable computation units. For example, a cluster can include a multiplier-accumulator (MAC) unit, a multiplexer, a tensor reduction unit, a matrix reduction unit, a logic gate, or other suitable computation units.

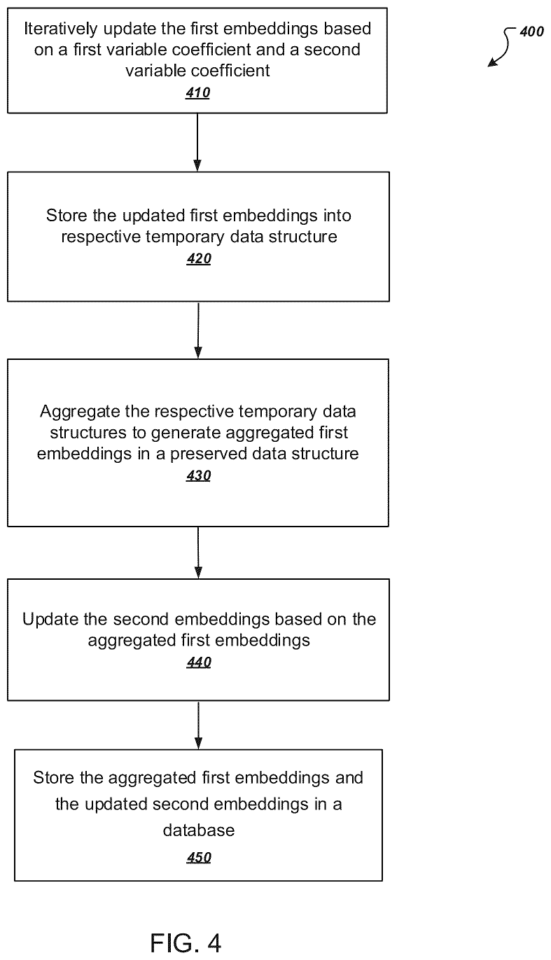

System 200 is configured to update user account embeddings and item embeddings using matrix factorization techniques. In general, for streaming data received during a specified time period, the system 200 updates the user account embeddings asynchronously using multiple clusters (e.g., accelerators). After synchronizing the updates in user account embeddings, the system 200 “freezes” the updated user account embeddings (i.e., treating the user account embeddings as constants and keeping their values fixed), and updates item embeddings based on the “fixed” user account embeddings. The details of updating embeddings for a batch of streaming data 210 in a time period are described in connection with FIG. 4.

In general, the processor 220 instructs the clusters 215A-215N to update embeddings using an asymmetric update technique 225. The asymmetric update technique includes one or more gate functions for controlling embedding updates given input training data. One example gate function can represent historical update counts for a user account embedding or an item embedding. Alternatively or in addition, another example gate function can include a ratio of historical update counts for a particular user account to all historical update counts for all user accounts. The asymmetry of the update techniques is due to the introduction of the above-noted gate functions. The detailed expressions of the gate functions are described in connection with FIG. 4.

For each time period, the processor 220 is configured to iteratively update user account embeddings before reaching a check point. The check point can include one or more criteria such as reaching a threshold number of iterations, satisfying a convergence criterion, or satisfying a threshold time value for updating the user account embeddings. Each cluster 215 included in the processor 200 is configured to process a portion of the received streaming data 210, and update user account embeddings concurrently for the time period. More specifically, the clusters 215A-N are configured to asynchronously update embeddings based on respectively assigned streaming data 210. In other words, after reaching a check point, clusters 215A-N do not need to synchronize the respective updates with one another, rather, each cluster 215 can update embeddings independently to a memory unit 250 included in the system 200.

Memory unit 250 generally includes multiple temporary data structures 240A-S. Each temporary data structure 240 is configured to receive and store updates of embedding generated by a different agent (also referred to as a cluster 215 throughout the specification). A temporary data structure 240 can include different data structures, for example, a table structure, a vector structure, a matrix structure, or other suitable structures. The updates or the updated embeddings generated by different agents include at least updates for user account embeddings or the updated user account embeddings. In some implementations, the updates of embeddings can further include updates of metadata embeddings h i associated with items engaged with by corresponding user accounts. Since the agents perform updating operations asynchronously, the temporary data structures 240A-s accordingly store the updates in an asynchronous fashion.

As a illustrative example, a first cluster 215B can store, in the temporary data structure 240B, the updates of user account embeddings for user accounts 1 and 2, and optionally the updates of metadata embeddings for items 3 and 4 engaged with by the user accounts 1 and 2. A second cluster 215D can store, in the temporary data structure 240F, the updates of user account embeddings for user accounts 1, 3, and 4, and optionally the updates of metadata embeddings for items 1, 2, and 4 engaged with by the user accounts 1, 3, and 4.

The system 200 periodically synchronizes the updated embeddings stored in temporary data structures 240A-S using a query engine 260. The query engine 260 is configured to aggregate the temporary data 255 from the memory unit 250 as preserved data 265. To aggregate the temporary data 255, the query engine 260 is configured to determine an expected value for user account embeddings that are updated by multiple agents asynchronously, and add the expected value into corresponding user account embeddings stored in the preserved data for a previous time period. In some implementations, the query 260 can include a learning rate value for adjusting the updates generated from multiple agents. An example aggregation or synchronization action can be expressed as:

uᵢ^{τ}^{ₐ}^{+1,(DB)}=uᵢ^{τ}^{ₐ}^{+,(DB)}+σE_{w}(uᵢ^{τ}^{ₐ}^{+1,(w)}) Equation (1),

where uᵢ^{τ}^{ₐ}^{+1,(DB)} represents user account embeddings for time period τₐ+1 to be stored in a database 275, uᵢ^{τ}^{ₐ}^{+1,(DB)} represents user account embeddings for time period τₐ that have been stored in the database 275, uᵢ^{τ}^{ₐ}^{+1,(DB)} represents temporary user account embeddings for time period τₐ+1 updated by multiple agents w (e.g., clusters 215A-N), and σ is an hyperparameter (e.g., a learning rate) that controls the learning step-size. The learning rate σ can include different values ranging from 0 to 1. The expression E_{w}(*) generally refers to a function for calculating an expectation of updated user account embeddings from multiple agents. The computation of expectation of updated embeddings and the inclusion of a learning rate can provide strong resistance to overfitting. Note that the time periods τₐ+1 and τₐ are predetermined for aggregating updates from different agents, which are generally greater than the time periods for locally uploading embeddings on respective agents (the update process is described in detail in connection with FIG. 4). For example, the time interval between τₐ+1 and τₐ can be two hours, three hours, five hours, or more, while the time interval for local embedding updates can be thirty minutes, one hour, or other suitable time periods smaller than two hours.

The query engine 260 is further configured to store the preserved data 265 for a current time period into the preserved data structure 270. The preserved data structure 270 can include different structures such as a table, a vector, a matrix, or other suitable structures. Referring to the naive example above, the query engine 260 can store in the preserved data structure 270 the updates of user account embeddings 1, 2, 3, and 4, and optionally the updates of metadata embeddings for items 1, 2, 3, and 4.

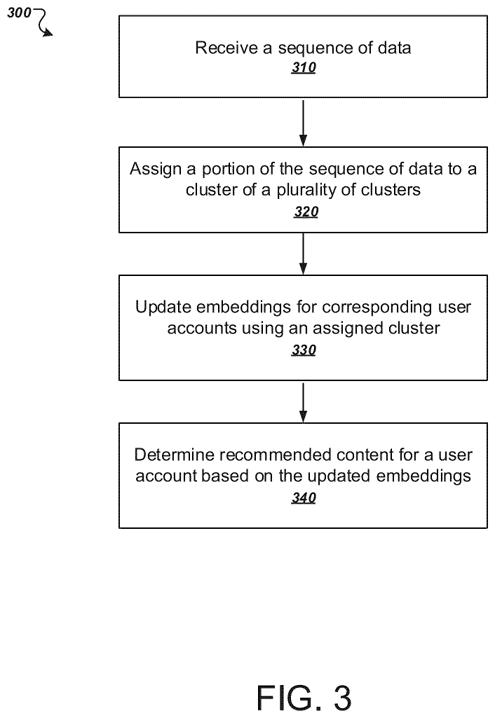

Note that the memory unit 250 can fetch the updated user account embeddings from the preserved data structure 270 through the query engine 260, and further provide the fetched user account embeddings to different agents for determining updates of item embeddings. The item embeddings are generally updated based on preserved user account embeddings and a measure of recency of the engagements (e.g., a time when an item was engaged by a user account). Similarly, the clusters 215A-N update the item embeddings asynchronously, and the query engine 260 aggregates the partial updates of item embeddings in the temporary data 255, and stores the updated item embeddings in the preserved data structure 270. The details of the update of item embeddings are described in connection with FIG. 3.

In some implementations, the system 200 can store the preserved data structure 270 to a database 275. Database 275 can include a distributed database. The database 275 can be included in the system 200 or be external to the system 200. As described above, the system determines output 280 based on the preserved user account embeddings and preserved item embeddings stored in the preserved data structure 270. Meanwhile, the system can continue to process new streaming data 210 received by the system 200 for a new time period, and update the embeddings by processing the new streaming data 210 as described above. In this way, the system 200 can continually update the embeddings and therefore accurately and efficiently determine customized content to recommend to user accounts.

The system 200 further includes a replay data structure 230 to store historical streaming data 210 to prevent “forgetting” previously learned embeddings. The replay data structure 230 can include different structures such as a table, a vector, a matrix, or other suitable structures. In general, the replay data structure 230 can store streaming data 210 for some collection of user accounts for multiple time periods. For example, the replay data structure 230 can include the last interaction or engagement of a group of user accounts with corresponding items. Alternatively, the replay data structure 230 can store more than one engagement for a user account, e.g., the three, five, ten, or more lasted interactions for items. The group of user accounts can include at least a portion of all user accounts on the social messaging platform. During the training period, the processor 220 can receive, for each time period, replay data 235 including the top-N latest engagements (e.g., data tuples) indicating user accounts and corresponding items engaged by corresponding user accounts, in addition to the streaming data 210 for the time period. In this way, the system 200 can improve accuracy for determining embeddings for inactive user accounts.

FIG. 3 is a flowchart of an example process 300 for determining content to recommend to a particular user account. For convenience, the process 300 is described as being performed by a system of one or more computers located in one or more locations. For example, the process 300 can be performed by a social messaging platform, e.g., the social messaging platform 100 shown in FIG. 1. As another example, the process 300 can be performed by the interest recommendation system 112 of FIG. 1 or the interest recommendation system 200 shown in FIG. 2. The order of steps in the process 300 is illustrative only and can be performed in different orders. In some implementations, the process 300 can include additional steps, fewer steps, or some of the steps can be divided into multiple steps.

The system receives a sequence of data corresponding to a data stream time period (310). The sequence of data can be streaming data (e.g., streaming data 210 of FIG. 2) provided by a streaming engine. The sequence of data generally includes data associated with multiple user accounts that engaged with one or more items on the social messaging platform during the data stream time period, items that have been engaged with by corresponding user accounts, and metadata (or metadata embeddings for some situations) associated with the items. In some implementations, the sequence of data can include multiple data tuples according to an order, e.g., a chronological order, within data stream time period. Each data tuple can include data indicating a user account (e.g., a user account identifier) and one or more items (e.g., item identifiers) that the user account has engaged with during the data stream time period. The data stream time period can include different time periods according to different training step or inference step requirements. For example, a data stream time period can be thirty seconds, ten minutes, two hours, or other suitable time periods.

The system generally determines customized content for recommending to user accounts on the social messaging platform based on determined/updated embeddings. The system can update these embeddings for a next time period by analyzing a sequence of data received in a current data stream time period, and repeatedly update the embeddings process for other sequences of data received during subsequent data stream time periods.

As described above, a user account includes an account registered by an entity on the social messaging platform. An entity can include an individual user, an organization, or a business. An item on the social messaging platform can generally include messages and/or conversations posted on the platform. In some implementations, the item can further include content recommended to user accounts based on determined user interests. Such content can include one or more texts, images, videos, or information in other suitable forms. An item generally includes different properties, e.g., a topic, a keyword, a hashtag, a geographical location, a language, or an authorship associated with the item. For example, assuming an item includes a message posted on the social messaging platform, the message can include at least one or more of properties: a topic of the message, a keyword for the message, a hashtag posted with the message, a geographical location associated with the message, a language associated with the message, or an author account that posted the message.

The system assigns a portion of the sequence of data to each of multiple clusters (320). The portions generally represent the entire sequence of data received for the data stream time period. Each cluster can include multiple computation units for processing the assigned portion of the sequence of data. As described above, a computation unit can include a MAC unit, a multiplexer, a reduction unit, a permutation unit, a logic gate, or other suitable computation units according to different computation requirements. The system instructs the multiple clusters to process the respective portions concurrently and update embeddings asynchronously based on the respective portions.

The embeddings generally include two types of embeddings: first embeddings and second embeddings. The first embeddings generally include user account embeddings determined for particular user accounts in the received streaming data. The second embeddings generally include item embeddings determined for items engaged by corresponding user accounts in the received streaming data.

The system uses a group of metadata embeddings to update the user account embeddings and the item embeddings, assuming the metadata embeddings are “fixed” (i.e., not updating) for the time period.

The sequence of data can further include multiple engagement signals representing engagements between user accounts and items. In general, an engagement signal can indicate a measure of engagement between a user account and corresponding items engaged by the user account. Each engagement signal can be associated with a data tuple specifying a user account and corresponding items engaged by the user account for a stream period. For example, an engagement signal can be expressed as (i,j, τ), which indicates a measure of engagement of user account i with item j at a data stream time period τ. A measure of engagement can represent a positive or a negative engagement between a user account and an item.

In some implementations, the system updates the user account embeddings and the item embeddings using a metadata embedding matrix determined from a group of metadata embeddings. For example, the metadata embedding matrix can be generated by sampling one or more metadata embeddings from the group of metadata embeddings based on the respective engagement signals. An example expression of the metadata embedding matrix can be expressed as Equation (2) below:

\tilde{H}ᵢ^{τ}=[. . . hⱼ . . . , . . . hₖ . . . ] Equation (2),

wherein the term \tilde{H}ᵢ^{τ} represents a metadata embedding matrix for i^{th} user account for a time period τ, the multiple metadata embeddings before the “comma” in Equation (2) can include a set of engagement signals having positive engagement values, denoted as “(i, j, τ)∈s,” and the multiple metadata embeddings after the “comma” in Equation can include another set of engagement signals having negative engagement values, denoted as “(i, j, τ)∈s.” The metadata embeddings with negative engagement values can be sampled from the group of metadata embeddings based on the negative engagement signals. The sampling process includes uniform sampling, Gaussian sampling, or other suitable sampling processes.

For each of the portions of the sequence of data, the system updates embeddings for corresponding user accounts using an assigned cluster (330). As described above, each cluster asynchronously updates embeddings (e.g., user account embeddings) and stores the updated embeddings in temporary data structures. Furthermore, the system updates the user account embeddings iteratively for multiple iteration steps for the received streaming data. The update technique includes one or more gate functions based on historical counts of updates for user accounts. After synchronizing the updates of user account embeddings stored in temperature data structures, the system stores the synchronized user account embeddings in a preserved data structure. Based on the synchronized user account embeddings and the recency of engagements between user accounts and corresponding items, the system further updates item embeddings for the data stream time period. The details of updating embeddings are described in connection with FIG. 4.

In some implementations, the system can store the sequence of data received for the current time period in a replay data structure. For a subsequent time period after the current time period, the system can provide the stored sequence of data as a part of input data together with another sequence of data received for the subsequent time period. Both the stored sequence of data in the replay data structure and the other sequence of data are used for updating the embeddings.

The system determines recommended content for a user account associated with a particular user based on the updated embeddings (340). The updated embeddings can include user account embeddings, item embeddings, and optionally, metadata embeddings associated with the item embeddings. The system can determine recommended contents for user accounts using a similarity function. The similarity function is configured to determine a level of similarity between embeddings for contents and at least one of (i) item embeddings, (ii) user account embeddings, or (iii) metadata embeddings. The level of similarity can include a Euclidean distance between the content embeddings and updated embeddings in an embedding space. In some implementations, the similarity function can be based on the Approximated Nearest Neighbor (ANN) algorithms with negative Euclidean distance. The system can determine and rank multiple candidate contents based on the measure of similarity and select one or more contents (e.g., messages) based on the ranking. For example, the system can select the top-N ranked contents as the recommended content for recommending to user accounts.

In some implementations, the system can use metadata embeddings (either learned with other embeddings or received as input) to filter candidate contents for a particular property using cosine similarity with the ANN search. For example, entities associated with user accounts on a social messaging platform might demonstrate strong preference on posts that are informative or influential in their real-life setting, e.g., political topics in a particular region, the system can offset the strong preference by filtering out content related to metadata embeddings representing such political topics or geographical locations indicating such a particular region. Note that although using the ANN and the Euclidean distance to determine the recommended content for user accounts is described in this specification, the system can perform different techniques to refine recommended content, e.g., introducing a more sophistic model architecture, using one or more different ranking techniques, introducing factors considering user account feedbacks for the recommended content, or other suitable techniques.

FIG. 4 is a flowchart of an example process 400 of updating embeddings. For convenience, the process 400 is described as being performed by a system of one or more computers located in one or more locations. For example, the process 400 can be performed by a social messaging platform, e.g., the social messaging platform 100 shown in FIG. 1. As another example, the process 400 can be performed by the interest recommendation system 112 of FIG. 1 or the interest recommendation system 200 shown in FIG. 2. The order of steps in the process 400 is illustrative only, and can be performed in different orders. In some implementations, the process 400 can include additional steps, fewer steps, or some of the steps can be divided into multiple steps.

The system iteratively updates the first embeddings asynchronously using multiple agents (e.g., computation clusters 215A-N in FIG. 2) (410). The first embeddings include user account embeddings. The system can mitigate the stability issue for training by introducing asymmetry in an update technique. More specifically, the system includes one or more gate functions for updating the user account embeddings. The one or more gate functions are also referred to as one or more variable coefficients in the following description.

In some implementations, the one or more gate functions can include a “resistance gate function” (or a first variable coefficient) to resist redundant and/or unnecessary updates over embeddings that have been updated for a large number of times. The one or more gate functions can further include an “attention gate function” (also referred to as a second variable coefficient) to determine the “trustworthiness” of new streamlining data for updating the embeddings. One example of a resistant gate function can be expressed as:

$$α ( {η}_{i} ) = \frac{1}{1 + {log}_{2} ( {η}_{i} )} , \qquad Equation ( 3 )$$

where the resistance gate function α(ηᵢ) in Equation (3) is a function of a historical update count ηᵢ for the i^{th} user account. More specifically, the value of resistance gate function is inversely related to the historical update count, i.e., the greater the historical update count ηᵢ is, the smaller the value generated by the resistance gate function α(ηᵢ). The value generally refers to a resistance coefficient or a first coefficient, which can be a scalar from zero to one, and/or a vector with entries each having a value range from zero to one. One example of an attention gate function can be expressed as:

$$β ( {η}_{i} ) = \frac{{log}_{2} ( {ζ}_{i} )}{Σ {log}_{2} ( {ζ}_{i} )} , \qquad Equation ( 4 )$$

where ζᵢ={ηⱼ|(i,j)∈s} represents a list of all historical update counts of corresponding items engaged with by the i^{th} user account in the training process, and therefore the attention gate function β(ηᵢ) in Equation (4) is also a function of historical update counts ηᵢ for the i^{th} user account. More specifically, the attention gate function β(ηᵢ) is a ratio between the historical update counts associated with a particular user account to that associated with all user accounts in the training process. The value generated by the attention gate function β(ηᵢ) generally refers to an attention coefficient or a second coefficient, which can be a scalar from zero to one, and/or a vector with entries each having a value range from zero to one.

Based on the first and second variable coefficients, the update technique for user account embedding can be expressed as below:

uᵢ^{τ+1}=(1=α(ηᵢ))uᵢ^{τ}+α(ηᵢ)(H^{T}eye(β(ζᵢ))H+λI)⁻¹Hrᵢ Equation (5),

where uᵢ^{τ} represents a user account embedding for the i^{th} user at the iteration step τ. As shown in Equation (5), the eye(*) function is a function that converts a vector into a matrix with diagonal entries being the elements of the vector according to an order, and other entries in the matrix are zeros.

The term H in Equation (5) can be a vector or a matrix including metadata embeddings for a particular property of the items. For example the term H can include topic embeddings for items (e.g., messages) in the streaming data. The term H can be expressed as H=[h₁, h₂, . . . , hⱼ], where h i represents a metadata embedding for a particular property of item j. The metadata embeddings H are “frozen” and not updated when updating the user account embeddings. In some implementations, the term H can be slightly manipulated by the system for a smaller size, e.g., the system can, based on the term H, generate metadata embedding matrix \tilde{H}, as expressed in Equation (2). As described above, the metadata embedding matrix \tilde{H} can be determined by sampling negative engagements from the metadata embeddings and the sampled embeddings can be arranged in a way similar to that expressed in Equation (2). In this case, the system can simply replace the term H with the metadata embedding matrix \tilde{H} to avoid reaching the “bottleneck” of the memory bandwidth.

The term rᵢ in Equation (5) generally indicates a vector of values each representing an interaction between user account i and item j. If the user account did not engage with item j, term r_{i,j}=0, otherwise, term r_{i,j}=1vice versa. In other words, the term rᵢ represents corresponding engagement values for user account i engaging with all items in the streaming data during a time period.

For each iteration step T, the user account embeddings uᵢ^{τ+1} for the next iteration step τ+1 are updated based on the user account embeddings uᵢ^{τ} for the current iteration step τ, the metadata embeddings for the data stream time period H or \tilde{H}, the interaction values rᵢ, and the first and second variable coefficients.

In general, the system continuously trains models for determining user account embeddings using new incoming data streams. The system therefore keeps tracking changes in user account embeddings based on user account activities in the social messaging platform included in the data streams, and updates user account embeddings using the above-noted techniques. As described above, the system decreases the amount of updates to user account embeddings that have been updated a large number of times due to the resistance gate being negatively proportional to the update times. In addition, the system decreases the amount of updates to user account embeddings that have a small attention gate value.

In some implementations, the system iteratively provides user account updates to a memory unit periodically, e.g., each time when reaching a check point for updating the embeddings. The check point can include one or more criteria such as reaching a threshold number of iterations, satisfying a convergence criterion, or satisfying a threshold time value for updating the user account embeddings, as described above. For example, the check point can be a time period that is smaller than a time period predetermined for aggregating embedding updates from multiple agents on a query engine.

After reaching the check point, the system instructs the multiple agents to store updated first embeddings for corresponding portions of the sequence of data into respective temporary data structures (420). Each agent can store its respective user account embeddings asynchronously in a respective temporary data structure in a memory unit, as described above.

Periodically, the system aggregates the respective temporary data structures to generate aggregated first embeddings in a preserved data structure (430). More specifically, the system can include a query engine to fetch temporary data from the temporary data structures and synchronize the updates of first embeddings to generate aggregated/synchronized first embeddings (e.g., user account embeddings) and store them in a preserved data structure. The aggregation includes aggregating updates in user account embeddings, received from corresponding agents, using a learning rate σ, and one example aggregation technique for each temporary data structure from a respective cluster is expressed in Equation (1), as described above. The synchronization process is performed periodically according to different update requirements, for example, for every 5 minutes, 30 minutes, one hour, two hours, or other suitable periods.

The system updates the second embeddings based on the aggregated first embeddings (440). The second embeddings include item embeddings. When updating the item embeddings, the system “freezes” and does not update the aggregated user account embeddings. Assuming a user account would prefer an item that is located closer to the user account than that farther away in the embedding space, and might show a stronger preference for an items engaged by the user account at a more recent time than that at an earlier time, one example update technique for the item embeddings can be expressed as:

argminᵥΣᵢΣⱼw(t_{i,j})(uᵢ−vⱼ)²I[(i,j)∈s] Equation (6),

where vᵢ represents an item embedding for the i^{th} item for the time period, uᵢ represents a user account embedding for the i^{th} user account for the time period, and the function I[*] generally refers to a logic function such that the value of the function I depends on whether a statement is satisfied (e.g., whether (i,j)∈s). For example, if the statement is satisfied, the value of function I can be a non-zero value, and if the statement is not satisfied. the value of function I can be zero. The term w(t_{i,j}) is a weight function determined by the system, and the term t_{i,j} represents a time point t when an i^{th} user account engaged with the j^{th} item. The weight function w(t_{i,j}) is accordingly dependent on the time points when engagements occurred, which can be expressed as:

w(t_{i,j})≥w(t_{i′,j′}) if t_{i,j} is more recent than t_{i′,j′}, Equation (7).

One example weight function can be determined based on a time period between an initial time when a particular content (e.g., a message) is posted to the social messaging platform and an engagement time when a particular user account engages with the particular content. Since multiple user accounts can engage with the same particular content, the weight function can further be determined by generating an expected time period from multiple time periods each between the initial time and respective engagement times with the particular content. The weight function can be, for example, inversely proportional to the expected time period.

The system can update the item embeddings by optimizing the objective function as expressed in Equation (6) and determine an explicit update technique for item embeddings as below:

vᵢ=E_{\tilde{w}(t}_{_{i,j}}₎[uᵢ]=Σᵢ\tilde{w}(t_{i,j})uᵢ Equation (8),

where function E(*) represents an expectation value of user account embeddings based on the weights \tilde{w}(t_{i,j}), which represent normalized weights of w(t_{i,j}) such as Σᵢ\tilde{w}(t_{i,j})=Σᵢw(t_{i,j})=1. Note that the superscript for the time period is omitted.

In some implementations, the system can update item embeddings on the fly, e.g., the system can maintain an updated version of item embeddings all the time after a new item (e.g., a new message) is added or posted into the social messaging platform. To achieve this, the system can slightly adjust the Equation (8) based on the incremental calculation rule of the weighted expectation. One example real-time update technique for item embeddings can be expressed as follows:

$${v}_{j}^{τ + 1} = \frac{{Σ}_{{i}^{′}} w ( {t}_{{i}^{′} , j} ) - w ( {t}_{i , j} )}{{Σ}_{{i}^{′}} w ( {t}_{{i}^{′} , j} )} {v}_{j}^{τ} + ( 1 - \frac{{Σ}_{{i}^{′}} w ( {t}_{{i}^{′} , j} ) - w ( {t}_{i , j} )}{{Σ}_{{i}^{′}} w ( {t}_{{i}^{′} , j} )} ) {u}_{i} \qquad Equation ( 9 )$$

where user account i is the latest user account that has engaged with item j for the current time period, vⱼ^{τ+1} represents the item embedding for the j^{th} item at the iteration step τ+1, and vⱼ^{τ} represents the item embedding for the jth item at the iteration step τ. The user account embeddings uᵢ are determined for the time period and stay fixed for the iterative update process of item embeddings.

The system can optionally store the aggregated first embeddings and the updated second embeddings in a database (450). As described above, the system can optionally store the update embeddings in a database for downstream operations. For example, one or more downstream engines can determine content based on the updated embeddings for recommending to user accounts. As another example, a downstream engine can generate a report based on the embeddings for one or more authoring accounts (e.g., content providers) in the social messaging platform, where the report can indicate how well the content provided by the authoring accounts are accepted by user accounts in the social messaging platform.

In some implementations, a user can have control over what information is collected by the social messaging platform, how the collected information is used, and what information is provided to a user. In general, a user can be provided with controls through a user interface so that a user can decide if and when the social messaging platform can collect information related to the user (e.g., user's personal identification information such as age, gender, or profession, historical activities on the social messaging platform, geographical information, or preferences). In some implementations, the social messaging platform can only collect information that is consent by a user. In some implementations, user information is modified or filtered by one or more computers located at different locations before being received by the social messaging platform. For example, a user's personal identification information can be filtered or removed from other information provided to the social messaging platform, so that, e.g., the user's age, gender, profession, or geographical location are not provided. Alternatively, a system can encode a user's identification information when provided to the social messaging platform so that the user identification information is secured and cannot be obtained.

Referring back to the components shown in FIG. 1, the following paragraphs provide further information about the platform and its clients.

### User Devices and Clients

On any particular user device, the client may be a web browser and an HTML (hypertext markup language) document rendered by the web browser. The client may be or include JavaScript code or Java code. Or the client may be dedicated software, e.g., an installed app or installed application, that is designed to work specifically with the platform. The client may include, for example, a Short Messaging Service (SMS) interface, an instant messaging interface, an email-based interface, and HTML-based interface, or an API function-based interface for interacting with the platform.

A user device can include a camera, microphone, or both, and the client can include or be coupled to software to record pictures, audio, and video. The user device can include both a front-facing, i.e., a user-facing camera, and a rear-facing camera.

### Platform

The platform may have many millions of accounts, and anywhere from hundreds of thousands to millions of connections may be established or in use between clients and the platform at any given moment. The accounts may be accounts of individuals, businesses, or other entities, including, e.g., pseudonym accounts, novelty accounts, and so on.

The platform and client software are configured to enable users to draft messages and to use the platform, over data communication networks, to post messages to the platform and to receive messages posted by other users. The platform and client software are configured to enable users to post other kinds of content, e.g., image, video, or audio content, or a combination of kinds of content, either separately or combined with text messages.

Optionally, the platform is configured to enable users to define immediate or scheduled sessions with individual or groups of users for audio or audio and video interactions. The platform enables users to specify participation in such sessions using the relationships defined, i.e., in the connection graphs maintained by the platform.

The platform is configured to deliver content, generally messages, to users in their home feed stream. The messages will generally include messages from accounts the user is following, meaning that the recipient account has registered to receive messages posted by the following account. The platform generally also includes in the stream messages that the platform determines are likely to be of interest to the recipient, e.g., messages on topics of particular current interest, as represented by the number of messages on the topics posted by platform users, or messages posted on topics of apparent interest to the recipient, as represented by messages the recipient has posted or engaged with, or messages on topics the recipient has expressly identified to the platform as being of interest to the recipient, as well as selected advertisements, public service announcements, promoted content, or the like.

The platform enables users to send messages directly to one or more other users of the platform, allowing the sender and recipients to have a private exchange of messages. The platform is configured with interfaces through which a client can post messages directed to other users, both synchronously and asynchronously. Thus, users are able to exchange messages in real-time, i.e., with a minimal delay, creating what are essentially live conversations, or to respond to messages posted earlier, on the order of hours or days or even longer.

The platform also indexes content items and access data that characterizes users' access to content. The platform provides interfaces that enable users to use their clients to search for users, content items, and other entities on the platform.

### Messages

Generally, a message posted on the platform contains data representing content provided or selected by the author of the message. The message may be an instance of a container data type storing the content data. The types of data that may be stored in a message include text, graphics, images, video, and computer code, e.g., uniform resource locators (URLs), for example. Messages can also include key phrases, e.g., hashtags, that can aid in categorizing messages or in linking messages to topics. Messages can also include metadata that may or may not be editable by the message author or account holder, depending on what the platform permits. Examples of message metadata include a time and date of authorship and a geographical location of the user device when the client posted the message. In some implementations, what metadata is provided to the platform by a client is determined by privacy settings controlled by the user or the account holder.

Messages composed by one account holder may include references to other accounts, other messages, or both. For example, a message may be composed in reply to another message posted by another account or by the user. Messages may also be republicans of messages received from another account. Generally, an account referenced in a message may appear as visible content in the message, e.g., as the name of the account, and may also appear as metadata in the message. As a result, the referenced accounts can be interactive in the platform. For example, users may interact with account names that appear in their message stream to navigate to message streams of those accounts. The platform also allows users to designate particular messages as private; a private message will only appear in the message streams of the composing and recipient accounts.

Generally, messages on the platform are microblog posts, which differ from email messages in a number of ways, for example, in that an author of the post does not necessarily need to specify, or even know, which accounts the platform will select to provide the message to.

### Streams

A stream is an ordered collection of messages on the platform that meet one or more stream criteria. A stream can be defined by the stream criteria to include messages posted by one or more accounts. For example, the content of a stream for a requesting account holder may include one or more of (i) messages composed by that account holder, (ii) messages composed by the other accounts that the requested account holder follows, (iii) messages authored by other accounts that reference the requested account holder, or (iv) messages sponsored by third parties for inclusion in the account holder's message stream. The messages of a stream may be ordered chronologically by time and date of authorship, or reverse chronologically. Streams may also be ordered in other ways, e.g., according to a computationally predicted relevance to the requesting account holder, or according to some combination of time and relevance score.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and some or all of the remainder are sent in response to subsequent client requests.

### Relationships

Accounts will generally have relationships with other accounts on the platform.

Relationships between accounts of the platform are represented by connection data maintained by the platform, e.g., in the form of data representing one or more connection graphs. The connection data can be maintained in a connection repository. Data repositories of the platform are generally stored in distributed replicas for high throughput and reliability. A connection graph includes nodes representing accounts of the platform and edges connecting the nodes according to the respective relationships between the entities represented by the nodes. A relationship may be any kind of association between accounts, e.g., a following, friending, subscribing, tracking, liking, tagging, or other relationship. The edges of the connection graph may be directed or undirected based on the type of relationship.

The platform can also represent relationships between accounts and entities other than accounts. For example, when an account belongs to a company, a team, a government, or other organized group, a relationship with that account can also be, for example, a relationship of being a member of the group, having a particular role in the group, or being an expert about the group. The platform can also represent abstract entities, e.g., topics, activities, or philosophies, as entities that can have relationships with accounts and, in some implementations, other entities. Such relationships can also be represented in a common connection graph or in one or more separate connection graphs, as described above.

### Engagements

The platform records user engagements with messages and maintains, in a message repository, data that describes and represents at least a collection of recent messages as well as the engagements with the messages.

Engagement data relative to messages includes data representing user activity with respect to messages. Examples of engagement by a user with a message include reposting the message, marking the message to indicate it is a favorite of, liked by, or endorsed by the user, responding to the message, responding to a message with a response having a sentiment determined by the platform to be positive or negative, quoting the message with further comments, and mentioning or referencing the message.

Engagement data relative to accounts includes data representing connections between accounts. Examples of engagements by a user with respect to an account include aggregated measures of engagement with messages authored by the account. Other examples include how many followers and followers the account has, i.e., how many other accounts are following the account and how many other accounts the account is following. Other examples include measures of similarity between the groups of followers, the groups of followers, or both, of two accounts, including non-account followers.

Data about engagements can be represented on the platform as graphs with connections between accounts and messages, and stored in a graph repository.

### Services Provided by Platform Servers

The servers of the platform perform a number of different services that are implemented by software installed and running on the servers. The services will be described as being performed by software modules. In some cases, particular servers may be dedicated to performing one or a few particular services and only have installed those components of the software modules needed for the particular services. Some modules will generally be installed on most or all of the non-special-purpose servers of the platform. In some cases, multiple instances of a module may operate in parallel so as to complete a request for service within a short period of time, so that the platform can respond to users with low latency. The software of each module may be implemented in any convenient form, and parts of a module may be distributed across multiple computers in one or more locations so that the operations of the module are performed by multiple computers running software performing the operations in cooperation with each other. In some implementations, some of the operations of a module are performed by special-purpose hardware.

### Front End Services

In some implementations, the platform includes numerous different but functionally equivalent front end servers, which are dedicated to managing network connections with remote clients.

The front end servers provide a variety of interfaces for interacting with different types of clients. For example, when a web browser accesses the platform, a web interface module in the front end module provides the client access. Similarly, when a client calls an API made available by the platform for such a purpose, an API interface provides the client access.

The front end servers are configured to communicate with other servers of the platform, which carry out the bulk of the computational processing performed by the platform as a whole.

### Routing Services

A routing module stores newly composed messages in a message repository. The routing module also stores an identifier for each message. The identifier is used to identify a message that is to be included in a stream. This allows the message to be stored only once and accessed for a variety of different streams without needing to store more than one copy of the message.

### Relationship Graph Services

A graph module manages connections between accounts, between accounts and entities, and between entities. Connections determine which streams include messages from which accounts. In some implementations, the platform uses unidirectional connections between accounts and streams to allow account holders to subscribe to the message streams of other accounts. A unidirectional connection does not imply any sort of reciprocal relationship. An account holder who establishes a unidirectional connection to receive another account's message stream may be referred to as a “follower,” and the act of creating the unidirectional connection is referred to as “following” another account.

The graph module receives client requests to create and delete unidirectional connections between accounts and updates the connection graph or graphs accordingly. Similarly, for entities that are represented by the platform as entities with which accounts can have relationships, the graph module can also receive client requests to create and delete connections representing account-to-entity relationships.

### Recommendation Services

A recommendation module of the platform can recommend content, accounts, topics, or entities to a user. The recommendation module specifically tailors recommendations to the user.

A user or a client can generate a request for a recommendation, or another module of the platform can generate a request for a recommendation on its own, e.g., in order to include a recommendation in a stream being generated for a user. A recommendation can be a call to action, i.e., a suggestion that the user take a particular action, or the recommendation can be the recommended content itself, e.g., a message to include in the stream. The recommendation module can also provide a recommendation in response to a user action that does not explicitly request a recommendation, e.g., interacting with content on the platform in a way that indicates interest.

The recommendation module makes recommendations using, for example, information users provided about themselves and other data found in the users' profiles, and data about the users' engagements and relationships stored in graph data and otherwise in the platform's repositories.

To make a recommendation for a user, that user's behavior and other users' behaviors are taken into account. Thus, the relationships and interactions between (i) a user, on the one hand, and (ii) content or users or other entities, on the other hand, are used to make personalized content recommendations for the user. In addition to being presented to the user by a client, recommendations can be provided without going through the client, e.g., in an email, text message, or push notification. Recommendations can also identify, in a personalized way, content popular near a certain geographic location, or real-time trending topics.

The platform maintains data, especially about live events, with a high degree of currency and for quick access, so that the platform can provide recommendations of current interest, especially during live events.

In some implementations, the platform presents with a recommendation user-related reasons for the recommendation, e.g., because a message relates to a topic followed by the user or to a trending topic or to a topic trending in the user's location, or because a message had strong engagement among the user's followers, or because the message was endorsed by other users sharing common interests or sharing common followed topics with the user. In some implementations, the platform ranks recommendations according to the reasons for the recommendations, giving preference to recommendations based on endorsements from followers, experts, or celebrities.

### Delivery Services

A delivery module constructs message streams and provides them to requesting clients, for example, through a front end server. Responding to a request for a stream, the delivery module either generates the stream in real time, or accesses from a stream repository some or all of a stream that has already been generated. The delivery module stores generated streams in the stream repository. An account holder may request any of their own streams, or the streams of any other account that they are permitted to access based on privacy and security settings. If a stream includes a large number of messages, the delivery module generally identifies a subset of the messages to send to a requesting client, in which case the remaining messages are maintained in a stream repository from which more messages are sent upon client request.

### Health and Safety

The platform includes modules that enable users to filter the content they receive from the platform. For example, users may select settings that cause the platform to filter out sensitive content. The platform also enables a user to control how the user is visible on the platform. For example, the platform enables a user to prevent particular users from following the user, from viewing the user's messages on the platform, from sending messages directed to the user, or from tagging the user in a photo. The platform also enables a user to mute particular users to prevent messages from particular users from being included in any incoming streams, or to block incoming push or SMS notifications from particular users. The platform enables a user to mute another user while continuing to be a follower of the other user.

In addition, the platform itself can filter out content that is identified by the platform as toxic or abusive, or that originates from accounts identified by the platform as toxic or abusive, with or without a user request to do so.

### Account Services

An account module enables account holders to manage their platform accounts. The account module allows an account holder to manage privacy and security settings, and their connections to other account holders. In particular, a user can choose to be anonymous on the platform. Data about each account is stored in an account repository.

### Engagement Services

Client software allows account holders receiving a stream to engage, e.g., interact with, comment on, or repost, the messages in the stream. An engagement module receives these engagements and stores them in an engagement repository. Types of engagement include selecting a message for more information regarding the message, selecting a URI (universal resource identifier) or hashtag in a message, reposting the message, or making a message a favorite. Other example engagement types include opening a card included in a message, which presents additional content, e.g., an image, that represents a target of a link in the message, or that links to an application installed on the user device. Account holders may engage further with the additional content, e.g., by playing a video or audio file or by voting in a poll.

In addition to recording active interactions with messages through explicitly received user input, the engagement module may also record passive interactions with messages. An impression occurs when a client presents the content of a message on a user device. Impression engagements include the mere fact that an impression occurred, as well as other information, e.g., whether a message in a stream appeared on a display of the user device, and how long the message appeared on the display.

Any engagement stored in the engagement repository may reference the messages, accounts, or streams involved in the engagement.

Engagements may also be categorized beyond their type. Example categories include engagements expressing a positive sentiment about a message (“positive engagements”), engagements expressing a negative sentiment about a message (“negative engagements”), engagements that allow an account to receive monetary compensation (“monetizable engagements”), engagements that are expected to result in additional future engagements (“performance engagements”), or engagements that are likely to result in one account holder following another account (“connection engagements”). The negative engagements category includes, for example, engagements dismissing a message or reporting a message as offensive, while the positive engagements category typically includes engagements not in the negative engagements category. Example performance engagements include selecting a URL in a message or expanding a card. Example monetizable engagements include, for example, engagements that result in an eventual purchase or a software application installation on a user device. Generally, categories and types are not coextensive, and a given type of engagement may fall into more than one category and vice versa.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by a data processing apparatus, cause the apparatus to perform those operations or actions. That special-purpose logic circuitry is configured to perform particular operations or actions means that the circuitry has electronic logic that performs those operations or actions.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

In addition to the embodiments described above, the following embodiments are also innovative:

Embodiment 1 is a method, comprising: receiving, in a data stream time period, a sequence of data that comprises a plurality of data tuples, each data tuple indicating a user account and an item that the user account engaged with on the social messaging platform; assigning a portion of the sequence of data to a respective cluster of a plurality of clusters, wherein the combined portions represent the entire sequence of data; for each of the portions of the sequence of data, updating embeddings for corresponding user accounts using an assigned cluster, wherein the embeddings comprise first embeddings and second embeddings, the updating comprising: for each iteration step of a plurality of iteration steps, updating the first embeddings based on a first variable coefficient and a second variable coefficient; storing, by each of the clusters, the updated first embeddings for corresponding portions of the sequence of data into respective temporary data structures; aggregating the respective temporary data structures to generate aggregated first embeddings in a preserved data structure; updating the second embeddings based on the aggregated first embeddings; and storing the aggregated first embeddings and the updated second embeddings in a database.

Embodiment 2 is the method of Embodiment 1, wherein the first embeddings comprise user account embeddings for the corresponding user accounts in the corresponding portions, wherein the second embeddings comprise item embeddings for corresponding items engaged by the corresponding user accounts.

Embodiment 3 is the method of Embodiment 2, wherein the sequence of data further comprise a group of metadata embeddings determined for corresponding items in the sequence of data, and respective engagement signals each indicating a measure of engagement during the data stream time period between a user account and a corresponding item.

Embodiment 4 is the method of Embodiment 3, wherein the measure of engagement includes an engagement value indicating a positive engagement or a negative engagement for a user account engaging with a corresponding item during the data stream time period.

Embodiment 5 is the method of Embodiment 3 or 4, wherein the method further comprises: generating a metadata embedding matrix by sampling one or more metadata embeddings from the group of metadata embeddings based on the respective engagement signals.

Embodiment 6 is the method of Embodiment 5, wherein for each iteration step of a plurality of iteration steps, iteratively updating the first embeddings based on the first variable coefficient and the second variable coefficient comprises: updating user account embeddings for a next iteration step based on user account embeddings at the iteration step, the metadata embedding matrix for the data stream time period, the first variable coefficient, and the second variable coefficient.

Embodiment 7 is the method of any one of Embodiments 1-6, wherein aggregating the respective temporary data structures to generate the aggregated first embeddings in a preserved data structure comprises: for each of the respective temporary data structures obtained by an assigned cluster, updating data in the preserved data structure that corresponds to data stored in the respective temporary data structure based on a learning rate.

Embodiment 8 is the method of any one of Embodiments 1-7, wherein updating the second embeddings based on the aggregated first embeddings comprises: generating a weighted sum of the aggregated first embeddings as the updated the second embeddings, wherein each weight value for one of the aggregated first embeddings is based on an engagement time.

Embodiment 9 is the method of any one of Embodiments 1-8, further comprising: storing the sequence of data in a replay data structure; and providing the sequence of data in a second data stream time period, for updating the embeddings, wherein the second data stream time period is later than the data stream time period.

Embodiment 10 is the method of any one of Embodiments 1-9, further comprising: determining recommended content for a user account based on the aggregated first embeddings and the updated second embeddings, wherein the recommended content comprises data related to interests determined for the user account.

Embodiment 11 is the method of any one of Embodiments 1-10, wherein an item that a user account engages in a data tuple of the plurality of data tuples includes a message posted on the social messaging platform, wherein the message comprises at least one or more of properties: a topic of the message, a keyword for the message, a hashtag posted with the message, a geographical location associated with the message, a language associated with the message, or an author account that posted the message.

Embodiment 12 is a system comprising one or more computers and one or more storage devices storing instructions that when executed by one or more computers cause the one or more computers to perform respective operations, the operations comprising the method of any one of Embodiments 1-11.

Embodiment 13 is one or more computer-readable storage media storing instructions that when executed by one or more computers cause the one or more computers to perform respective operations, the respective operations comprising the method of any one of Embodiments 1-11.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A method for updating embeddings for user accounts on a social messaging platform, comprising:
receiving, in a data stream time period, a sequence of data that comprises a plurality of data tuples, each data tuple indicating a user account and an item that the user account engaged with on the social messaging platform;
assigning a portion of the sequence of data to a respective cluster of a plurality of clusters, wherein the combined portions represent the entire sequence of data;
for each of the portions of the sequence of data, updating embeddings for corresponding user accounts using an assigned cluster, wherein the embeddings comprise first embeddings and second embeddings, the updating comprising:
for each iteration step of a plurality of iteration steps, updating the first embeddings based on a first variable coefficient and a second variable coefficient;
storing, by each of the clusters, the updated first embeddings for corresponding portions of the sequence of data into respective temporary data structures;
aggregating the respective temporary data structures to generate aggregated first embeddings in a preserved data structure;
updating the second embeddings based on the aggregated first embeddings; and
storing the aggregated first embeddings and the updated second embeddings in a database.

2. The method of claim 1, wherein the first embeddings comprise user account embeddings for the corresponding user accounts in the corresponding portions, and wherein the second embeddings comprise item embeddings for corresponding items engaged by the corresponding user accounts.

3. The method of claim 2, wherein the sequence of data further comprise a group of metadata embeddings determined for corresponding items in the sequence of data, and respective engagement signals each indicating a measure of engagement during the data stream time period between a user account and a corresponding item.

4. The method of claim 3, wherein the measure of engagement includes an engagement value indicating a positive engagement or a negative engagement for a user account engaging with a corresponding item during the data stream time period.

5. The method of claim 3, wherein the method further comprises:
generating a metadata embedding matrix by sampling one or more metadata embeddings from the group of metadata embeddings based on the respective engagement signals.

6. The method of claim 5, wherein for each iteration step of a plurality of iteration steps, updating the first embeddings based on the first variable coefficient and the second variable coefficient comprises:
updating user account embeddings for a next iteration step based on user account embeddings at the iteration step, the metadata embedding matrix for the data stream time period, the first variable coefficient, and the second variable coefficient.

7. The method of claim 1, wherein aggregating the respective temporary data structures to generate the aggregated first embeddings in a preserved data structure comprises:
for each of the respective temporary data structures obtained by an assigned cluster, updating data in the preserved data structure that corresponds to data stored in the respective temporary data structure based on a learning rate.

8. The method of claim 1, wherein updating the second embeddings based on the aggregated first embeddings comprises:
generating a weighted sum of the aggregated first embeddings as the updated the second embeddings, wherein each weight value for one of the aggregated first embeddings is based on an engagement time.

9. The method of claim 1, further comprising:
storing the sequence of data in a replay data structure; and
providing the sequence of data in a second data stream time period, for updating the embeddings, wherein the second data stream time period is later than the data stream time period.

10. The method of claim 1, further comprising:
determining recommended content for a user account based on the aggregated first embeddings and the updated second embeddings, wherein the recommended content comprises data related to interests determined for the user account.

11. The method of claim 1, wherein an item that a user account engages in a data tuple of the plurality of data tuples includes a message posted on the social messaging platform, wherein the message comprises at least one or more of properties: a topic of the message, a keyword for the message, a hashtag posted with the message, a geographical location associated with the message, a language associated with the message, or an author account that posted the message.

12. A system comprising one or more computers and one or more storage devices storing instructions that when executed by one or more computers cause the one or more computers to perform respective operations, the operations comprising:
receiving, in a data stream time period, a sequence of data that comprises a plurality of data tuples, each data tuple indicating a user account and an item that the user account engaged with on the social messaging platform;
assigning a portion of the sequence of data to a respective cluster of a plurality of clusters, wherein the combined portions represent the entire sequence of data;
for each of the portions of the sequence of data, updating embeddings for corresponding user accounts using an assigned cluster, wherein the embeddings comprise first embeddings and second embeddings, the updating comprising:
for each iteration step of a plurality of iteration steps, updating the first embeddings based on a first variable coefficient and a second variable coefficient;
storing, by each of the clusters, the updated first embeddings for corresponding portions of the sequence of data into respective temporary data structures;
aggregating the respective temporary data structures to generate aggregated first embeddings in a preserved data structure;
updating the second embeddings based on the aggregated first embeddings; and
storing the aggregated first embeddings and the updated second embeddings in a database.

13. The system of claim 12, wherein the first embeddings comprise user account embeddings for the corresponding user accounts in the corresponding portions, and wherein the second embeddings comprise item embeddings for corresponding items engaged by the corresponding user accounts.

14. The system of claim 13, wherein the sequence of data further comprise a group of metadata embeddings determined for corresponding items in the sequence of data, and respective engagement signals each indicating a measure of engagement during the data stream time period between a user account and a corresponding item.

15. The system of claim 14, wherein the measure of engagement includes an engagement value indicating a positive engagement or a negative engagement for a user account engaging with a corresponding item during the data stream time period.

16. The system of claim 15, wherein the method further comprises:
generating a metadata embedding matrix by sampling one or more metadata embeddings from the group of metadata embeddings based on the respective engagement signals.

17. The system of claim 12, wherein updating the second embeddings based on the aggregated first embeddings comprises:
generating a weighted sum of the aggregated first embeddings as the updated the second embeddings, wherein each weight value for one of the aggregated first embeddings is based on an engagement time.

18. The system of claim 12, further comprising:
storing the sequence of data in a replay data structure; and
providing the sequence of data in a second data stream time period, for updating the embeddings, wherein the second data stream time period is later than the data stream time period.

19. One or more computer-readable storage media storing instructions that when executed by one or more computers cause the one or more computers to perform respective operations, the respective operations comprising:
receiving, in a data stream time period, a sequence of data that comprises a plurality of data tuples, each data tuple indicating a user account and an item that the user account engaged with on the social messaging platform;
assigning a portion of the sequence of data to a respective cluster of a plurality of clusters, wherein the combined portions represent the entire sequence of data;
for each of the portions of the sequence of data, updating embeddings for corresponding user accounts using an assigned cluster, wherein the embeddings comprise first embeddings and second embeddings, the updating comprising:
for each iteration step of a plurality of iteration steps, updating the first embeddings based on a first variable coefficient and a second variable coefficient;
storing, by each of the clusters, the updated first embeddings for corresponding portions of the sequence of data into respective temporary data structures;
aggregating the respective temporary data structures to generate aggregated first embeddings in a preserved data structure;
updating the second embeddings based on the aggregated first embeddings; and
storing the aggregated first embeddings and the updated second embeddings in a database.

20. The one or more computer-readable storage media of claim 19, wherein the first embeddings comprise user account embeddings for the corresponding user accounts in the corresponding portions, wherein the second embeddings comprise item embeddings for corresponding items engaged by the corresponding user accounts.
